(19) United States
(12) Patent Application Publication
(10) Pub. No.: US 2026/0056042 A1
(43) Pub. Date: Feb. 26, 2026

(54) LAMINAR FLOW ELEMENT

(71) Applicant: SIERRA INSTRUMENTS INC., Monterey, CA (US)

(72) Inventors: Enrique PRADO, Salinas, CA (US); Richard BREWER, Monterey, CA (US); Rafatou TAKPARA, Monterey, CA (US)

(21) Appl. No.: 19/307,686

(22) Filed: Aug. 22, 2025

Related U.S. Application Data
(60) Provisional application No. 63/685,951, filed on Aug. 22, 2024.

(51) Int. Cl. G01F 1/84

(52) U.S. Cl. CPC G01F 1/8413

(57) ABSTRACT

A laminar flow element including a single-piece layer of sheet stock having a first surface and a second surface opposite the first surface. The layer is an annular flat disk. The first surface includes at least one channel formed by etching. Sidewalls are formed by the at least one channel, the sidewalls having a height sufficient to create a transverse laminar flow.

### RELATED APPLICATION

This application claims priority to U.S. Provisional Application No. 63/685,951, filed Aug. 22, 2024, the entire contents incorporated herein by reference.

### FIELD OF DISCLOSURE

The present disclosure relates generally to a volumetric flow device using a laminar flow assembly, more specifically, the present disclosure relates to a laminar flow element of a single-piece layer of sheet stock.

### BACKGROUND

Flow meters are often used to sense the flowrate of a fluid traveling through a fluid channel. Such flow sensors are commonly used in a wide variety of applications including, for example, semiconductors, bioprocessing, scientific research, clean energy, medical applications, as well as many other applications. A mass flow meter is a device that directly measures the mass of a fluid passing through a specific point per unit of time, unlike volumetric flow meters. Mass flow meters are therefore a better choice for applications where density variations affect flow measurements. Mass flow meters utilize different technologies to determine the mass flow rate. In general, thermal mass flowmeters introduce heat into the flowing fluid and measure the temperature change, or the energy required to maintain a constant temperature, which correlates to the mass flow rate.

In most instances, testing and numerical simulations can be performed with a capillary flow meter, as shown in FIG. 1, which is a type of thermal mass flow meter that uses a small, heated capillary tube to measure the mass flow rate of gases. It works by diverting a small portion of the gas flow through the capillary tube (Q1), where the heat transfer from the gas to the tube is measured, providing a direct indication of the mass flow rate.

A Laminar Flow Element (LFE) is a critical component in thermal mass flow meters that creates a controlled flow path for a portion of the gas, allowing for accurate flow measurements. It essentially forces the gas flow to split, with a small fraction passing through the capillary tube (Q1) (i.e., sensor path) and the majority gas flow flowing through the LFE itself (Q2), as shown in FIG. 1. In other words, the LFE creates a bypass, with a small portion of the gas flow passing through the sensor, e.g., a resistance temperature detector (RTD) and the remaining flow passing through the LFE. The sensor measures the temperature change caused by the gas flow, which is then used to calculate the mass flow rate. LFEs provide a linear relationship between pressure drop and flow rate. LFEs are designed to minimize pressure drops, ensuring minimal disturbance to the flow, and contribute to the overall accuracy and repeatability of thermal mass flow meters.

Further, LFEs are designed to ensure laminar flow, meaning the fluid particles move in smooth, parallel layers. This type of flow meter is essential for accurate measurement because it allows for a predictable relationship between pressure drop and flow rate. It is well known that LFEs are used in a variety of applications, where precise and predictable flow measurement or control is needed, especially with gases.

A typical thermal mass flow meter employs a body configured to provide laminar fluid flow therethrough. As an example, flowing fluid from a conduit system enters an inlet process connection of the meter flow body, passes through a laminar flow assembly, exits through an outlet process connection of the flow body, and continues its flow within the conduit system. In passing through the laminar flow assembly, the fluid creates a pressure drop, P₁-P₂, across the LFE, which can be measured between the inlet and the outlet of the sensor tube. A manometer can be used to measure the pressure drop during the assembly procedure to aid in determining the correct number of LFE layers.

Further, laminar flow assemblies include one or more flow channels with dimensions sufficiently small that the passage of the fluid through them is laminar. Usually, the laminar flow assembly has either a transverse-flow geometry or an axial-flow geometry. One known laminar flow assembly with a transverse-flow geometry includes a plurality of annular disks fabricated of thin metal sheet stock compressively stacked together. Another known transverse flow laminar flow assembly has its open disks fabricated of thin metal sheet stock stacked together, wherein the flow enters a relatively large entry channel on one side of every open disk; passes through a multiplicity of small substantially rectangular laminar flow channels on one of the facets of each disk, all of which are recti-linearly directed (as opposed to radially directed) through the central portion of each open disk; and exits a relatively large exit channel on the opposite side of every open disk. In another version of the above second known transverse laminar flow assembly, disks between each said open disk act as gates which direct the flow in a serpentine-like pattern through the laminar flow assembly stack. Other known laminar flow assemblies with a transverse-flow geometry have alternative configurations designed to provide transverse flow paths through laminar flow channels of various shape.

There are several design options for the slices making up the laminar flow stack. In one variation, “open” slices are stacked with “closed” slices. In another variation, open slices are stacked upon one another, in an offset fashion in order that adjacent closed sections define top and bottom sections, whereas side sections of slices define side walls of the flow channels. Common to each variation is the stacking approach in which the edges of holes through layers and opposing surfaces of layers of the stack, together, form the flow channels. In the case of the alternating open/closed slice approach, the flow assembly has three identical transverse-flow rectangular laminar flow channels formed by three identical and generally pie-shaped flat washers equally spaced on the annular flat disk of the closed slice, forming a “multi-piece” device, as similarly shown in FIG. 3A. That is, adjacent layers of material in the individual slices employed in creating a stack provide both opposing surfaces of a flow channel (“top” and “bottom”) as oriented along the flow axis of an assembly. When assembled with adjacent slices, the slices form side walls of the three rectangular laminar flow channels. However, these multi-piece arrangements (i.e., 4-piece per layer) may cause non-laminar flow (turbulence or non-uniformity). More specifically, the particles in the fluid can be liable to be caught in-between the pieces, which may cause a measurement error due to pressure loss. In addition, since a plurality of disks are stacked together, the surface areas between the disks except for the flow passage portions are so large that it is difficult to purge the fluid intruded into gaps between the disks therefrom. This can result in contamination. In addition, the prior construction of the four-piece assembly allows possible movement or rotation of the three smaller pieces about their center axis, resulting in loss of cylindrical symmetry. As a result, this will also introduce non-linearities to the flow profile through the laminar flow element. Additionally, a problem associated with multi-piece construction is that it is difficult to clean the pieces when the disks are corroded or contaminated. A further problem is that the multi-piece layer construction is complicated, and therefore much time and labor are required to manufacture such a laminar flow device, increasing costs.

Therefore, there is a need in the art to provide a single-part or piece laminar flow element stacked on top of itself producing the same effect as a multi-part laminar flow elements, and addressing all of the problems discussed above.

### SUMMARY

In an example embodiment, a laminar flow element including a single-piece layer of sheet stock having a first surface and a second surface opposite the first surface. The layer is an annular flat disk. The first surface includes at least one channel formed by chemical etching. Sidewalls are formed by the at least one channel, wherein a height of the sidewalls is configured to create a transverse laminar flow.

In another example embodiment, a laminar flow assembly including a plurality of single-piece layers of sheet stock forming an interior transverse flow channel along an axis. Each layer includes a first surface and a second surface opposite the first surface, the layer being an annular flat disk. The first surface includes at least one channel formed by chemical etching. Sidewalls are formed by the at least one channel, wherein a height of the sidewalls is configured to create a transverse laminar flow.

### BRIEF DESCRIPTION OF THE DRAWINGS

Other features and advantages of the present invention will be apparent from the following more detailed description, taken in conjunction with the accompanying drawings which illustrate, by way of example, the principles of the invention.

FIG. 1 is a cross-sectional view of a conventional capillary flow meter.

FIGS. 2A-2C are perspective views of exemplary laminar flow assemblies.

FIG. 3A is a perspective view of a conventional laminar flow element.

FIG. 3B is a perspective view of an exemplary laminar flow element, according to an example embodiment of the present disclosure.

FIG. 4A is a perspective view of another exemplary laminar flow element, according to an example embodiment of the present disclosure.

FIG. 4B is a side view of the exemplary laminar flow element of FIG. 4A.

FIG. 4C is an enlarged view of the exemplary laminar flow element of FIG. 4B.

FIG. 5A is a perspective view of another exemplary laminar flow element, according to an example embodiment of the present disclosure.

FIG. 5B is a side view of the exemplary laminar flow element of FIG. 5A.

FIG. 5C is an enlarged view of the exemplary laminar flow element of FIG. 5B.

FIG. 6A is a perspective view of another exemplary laminar flow element, according to an example embodiment of the present disclosure.

FIG. 6B is a side view of the exemplary laminar flow element of FIG. 6A.

FIG. 6C is an enlarged view of the exemplary laminar flow element of FIG. 6B.

FIG. 7 is an exploded view of an exemplary laminar flow assembly, according to an example embodiment of the present disclosure.

FIG. 8 is a graph illustrating simulation and experimental testing results of pressure drops versus flowrate for different number of pie pieces, according to an example embodiment of the present disclosure.

FIG. 9A is a schematic view of an exemplary laminar flow element, according to an example embodiment of the present disclosure.

FIG. 9B is a schematic view of another exemplary laminar flow element V1, according to an example embodiment of the present disclosure.

FIG. 9C is a schematic view of another exemplary laminar flow element V2, according to an example embodiment of the present disclosure.

FIG. 9D is a schematic view of another exemplary laminar flow element V3, according to an example embodiment of the present disclosure.

FIGS. 10A and 10B are streamlines of simulation result of FIG. 9A, according to an example embodiment of the present disclosure.

FIGS. 11A and 11B are streamlines of simulation result of FIG. 9C, according to another example embodiment of the present disclosure.

FIGS. 12A and 12B are streamlines of simulation result of FIG. 9D, according to yet another example embodiment of the present disclosure.

FIG. 13 is a graph of the ratio of amplitudes of velocities Q2/Q1 according to yet embodiment of the present disclosure.

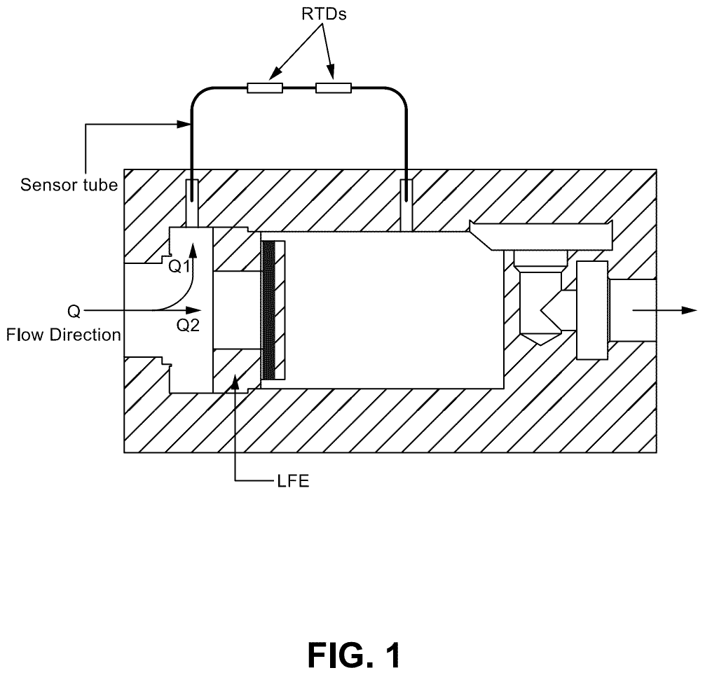

Wherever possible, the same reference numbers will be used throughout the drawings to represent the same parts.

### DETAILED DESCRIPTION OF EXAMPLE EMBODIMENTS

The present disclosure creates proper pressure differential regardless of the flow depending on how many units are stacked. In other words, the present disclosure creates a part that is consistent enough to produce proper linearity when stacking individual parts. As an example embodiment, a laminar flow element (LFE) consists of a single photo-etched device, rather than 4 individual parts as conventionally made. As such, this reduces the manufacturing time and therefore the production cost of the flowmeter/flow controller.

In addition, the assembly speed is increased and inventory/ordering simplicity is achieved. The present LFE allows for an easier stacking method giving a 10× production rate when compared to current stacking methods. Thus, making manufacturing more reproducible and increasing accuracy in flow measurements.

An example embodiment discloses a laminar flow element (LFE) in a laminar flow assembly that includes a single-piece layer of sheet stock having a first surface and a second surface opposite the first surface. The layer can be an annular flat disk fabricated from metal. The first surface includes at least one channel formed by chemical etching, and sidewalls are formed by the at least one channel, wherein the sidewalls have a height sufficient to create laminar flow. As compared to prior laminate flow elements, sides of the present flow channels may be provided as a single piece of material in a layer or slice of the assembly. By constructing a laminar flow element in this manner, uncontrollable radii along the flow channel as produced is avoided. Furthermore, flat stock selection for producing the layers can be obtained and conformed to very tight tolerances. Other problem resolved is the irreproducibility associated with etching to a desired depth channel. For instance, etching technique is complex and sometimes inaccurate-whereas the present disclosure simplifies the reproducibility by selecting a material stock of a desired height or thickness. Furthermore, by using stock in a stacked arrangement to define the flow channels, the surface finishes will be consistent, thus producing tight tolerances. Finally, channel number and width are easily set by virtue of the configuration of the open slices utilized in the structure.

The present disclosure provides a laminar flow device in which clogging due to particles is less prone to develop in the device. As such, this allows pressure to be properly adjusted and cleaning of the device can be easily affected.

Yet further, the present disclosure provides a laminar flow device in which rotation within the elements is difficult to attain or not possible. This removes a source of instability as generally found in the current devices.

When compared with those with laminar flow assemblies having multiple pieces laminar flow elements, those with a single-piece laminar flow element of the present disclosure offer advantages such as, but not limited to: compactness, ease of fabricating assemblies accommodating different total flow rates, and/or less dependence on flow disturbances or non-uniformities of the laminar flow assembly.

Aspects of the present disclosure offer one or more of: a) more reproducible laminar flow assembly-providing benefits of reduced cost and increased accuracy; b) more independence of flow disturbances upstream of the flow body—yielding benefits of increased accuracy and application of the instruments; c) more uniform flow entering the laminar flow assembly—providing benefits of increased accuracy; and/or d) reduced dynamic pressure (pQ²) effects—providing the benefit of increased accuracy.

As described herein, “layer” and “slice” are similar terms describing an annular flat disk of a metal sheet stock to form laminar flow channels.

As described herein, “single-piece” is similarly used to describe a device made as a unit, a whole integral part, monolithic or one-piece that is something unbroken, intact, undivided or whole.

For illustrative purposes, example embodiments as described herein can be applied by all instruments, such as, but not limited to, a mass flow controller, a volumetric flow meter, a volumetric flow controller, a mass flow meter, and a mass flow controller. For simplicity, the subject figures do not show a conduit, a mass flow sensor, and electronics. To better depict the flow through the open slices in the laminar flow assembly, more or less open slices are employed, and the thicknesses of the open slices and closed slices are exaggerated.

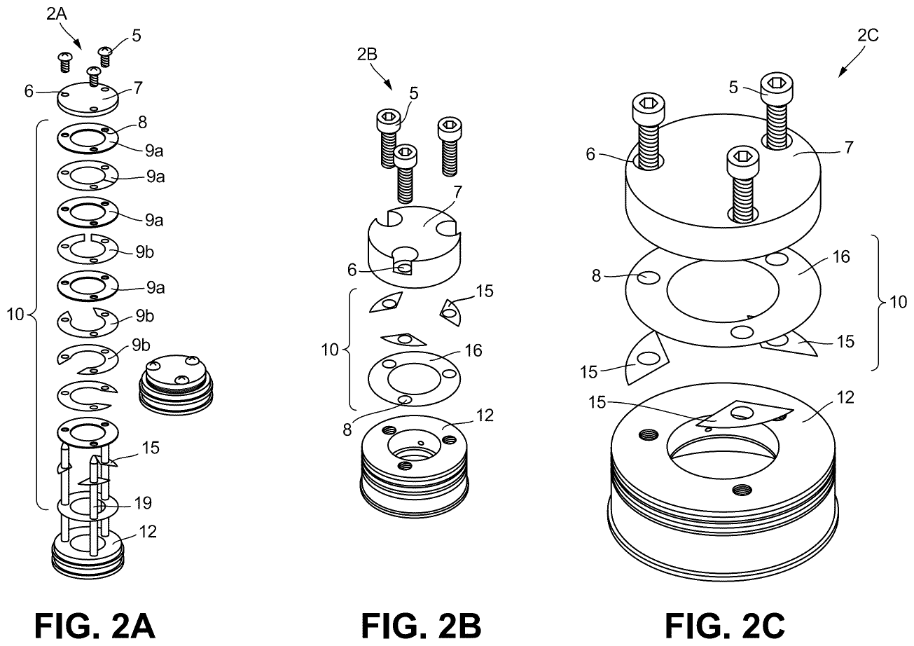

Referring now to the figures, FIGS. 2A-2C illustrate exemplary laminar flow assemblies 1A, 1B, 1C in which the present laminar flow element (LFE) can be used therewith. FIG. 2A shows a laminar flow assembly 1A used for low flow; FIG. 2B shows a laminar flow assembly 1B used for mid flow; and FIG. 2C shows a laminar flow assembly 1C used for high flow. As shown, each laminar flow assembly 1A, 1B, 1C has three equally spaced end plate screws 5 passing through respective clearance holes 6 in an end plate or cover 7 and holes 8 in all parts of a laminar flow element 10, having slices 9a, 9b in a stack configuration and inserted into a holder 12, creating a laminar flow assembly 1A, 1B, or 1C consisting essentially (from upstream to downstream) of the flow nozzle, the stack of slices, and the end plate. In some implementations, the holder 12 may contain guide posts 19 for sliding the slices 9a, 9b thereof. As shown, in example embodiments, the slices 9a, 9b can be of c-type slot or no slot.

In the alternative, other number of symmetrically arranged bolts or screws 5 can be threaded into the end plate 7. Even when sandwiched between the plates 7, the bolts or screws 5 and overall structure are adapted to evenly and tightly compress slices 9a, 9b defining the flow body. The screws 5 are tightened sufficiently so that the entire laminar flow assembly is tightly compressed with all parts secured in position and immovable, and the total transverse leakage flow rate between the slices in the stack is less than approximately 0.05% of the total flow rate passing through the rectangular laminar flow channels of the assembly and, therefore constitutes a negligible effect. It should be appreciated that the screws 5 can be of varying lengths depending on the final laminar flow element build.

In some implementations, various design options are provided for the slices making up the laminar flow stack. In one implementation, “open” slices are stacked with “closed” slices. In other implementation, open slices are stacked upon one another, in an offset fashion in order that adjacent closed sections define top and bottom sections, whereas side sections of slices define side walls of the flow channels. Common to each variation is the stacking approach in which the edges of holes through layers and opposing surfaces of layers of the stack, together, form the flow channels.

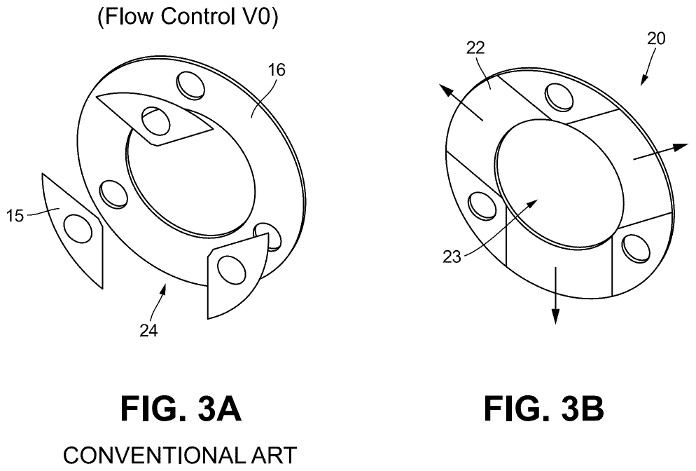

In the case of the alternating open/closed slice approach, the laminar flow assembly can have three identical transverse-flow rectangular laminar flow channels 24 formed by three identical and generally pie-shaped flat washers 15 equally spaced on an annular flat disk of a closed slice 16 (as specifically shown in FIG. 3A), designated as “a multi-piece device.” Each washer 15 preferably has: a) an outer radius equal to, and conforming with, that of the outer radius of the annular closed slice 16; b) an apex with a virtual radius equal to, and conforming with, that of the inner radius of the annular closed slice 16; and c) two straight sides angularly oriented so that, when assembled with adjacent closed slices, they form side walls of the three rectangular laminar flow channels 24 such that the width of all three flow channels 24 is equal and is constant over its average length, L. In this way, the side walls of the flow channel 24 are not radially oriented. As discussed herein, this configuration (i.e., multi-piece device) can produce non-laminar flow (turbulence or non-uniformity) in which particles in the fluid can become caught in-between the pieces. As such, this may cause a measurement error due to pressure loss—not to mention, the obvious time and cost in manufacturing a multi-piece device.

When comparing the laminar flow device of FIG. 3B, the present laminar flow element 20 is formed as a single-piece or unitary member. The laminar flow element 20 with a transverse-flow geometry is shaped as an annular disk fabricated from a thin metal sheet stock, for example. As mentioned, each disk element 20 can be compressively stacked together. Each such disk element 20 has one or more generally radially directed laminar flow channels 22 chemically etched, or otherwise etched or fabricated, into one facet of the disk, about a portion through the thickness of the disk. In one example, the etching process may etch about one-half thickness of the thickness of the disk, depending on the application and required specification. It is appreciated that other thicknesses can be employed. It should further be appreciated that the etching can be performed by chemical etching, wet etching or dry etching. Other methods can be employed to form the flow channels, such as, but not limited to, laser cutting, die cutting, stamping, etc.

As shown, there are three rectangular laminar flow channels 22, each having a thickness or height, a width, an average length, and a transverse fluid velocity vector (as shown by arrows) flowing outwardly from the internal bore 23 of the disk element 20 to an exit channel formed within a flow body bore (not shown). For clarity, the thicknesses of the flow channels 22 are exaggerated.

As for the various slices stacked to form the laminar flow body, the slices are formed from sheet stock with a thickness that is highly uniform and has tight tolerances. Shim stock as referenced above offers one exemplary starting material. Alternatively, the material may be stainless steel, or another material, and is not limited hereto. The material is advantageously cut into its desired shape by die cutting or stamping. Still, other manufacturing techniques can be employed.

In any case, a transverse flow laminar flow assembly according to the present disclosure typically comprises a plurality of slice layers of sheet stock. The sheet stock is advantageously metal shim stock in view of the tight tolerances available for such material. In order to foster laminar flow, layers forming transverse channels in the flow body will typically have a thickness of between about 0.001 and about 0.050 inches. Layers that only cap or provide a ceiling or floor of an open channel may be of any thickness. Alternatively, the layers on either or both sides of an open slice or layer may have a thickness of between about 0.001 and about 0.050 inches. Such an approach may be adopted simply to conserve space or for other manufacturing reasons. Still further, since the layers on either side of an open intermediate layer or slice may also be open in order to form one or more transverse channels, all of the layers may advantageously be provided in the same thickness.

It is to be understood that the channels 22 can have shapes other than the substantially rectangular-shaped shown, all variations of which are covered by the present disclosure. For example, for smaller flow bodies, the channels 22 may be substantially trapezoidal-shaped for the purpose of providing sufficient area for the end-screw clearance holes, yet still form rectangular laminar flow channels of equal width over their length. Additionally, substantially trapezoidal-shaped channels can have their two straight sides angled in such a manner that they create channels that direct their flow in a direction that is purely radially outward.

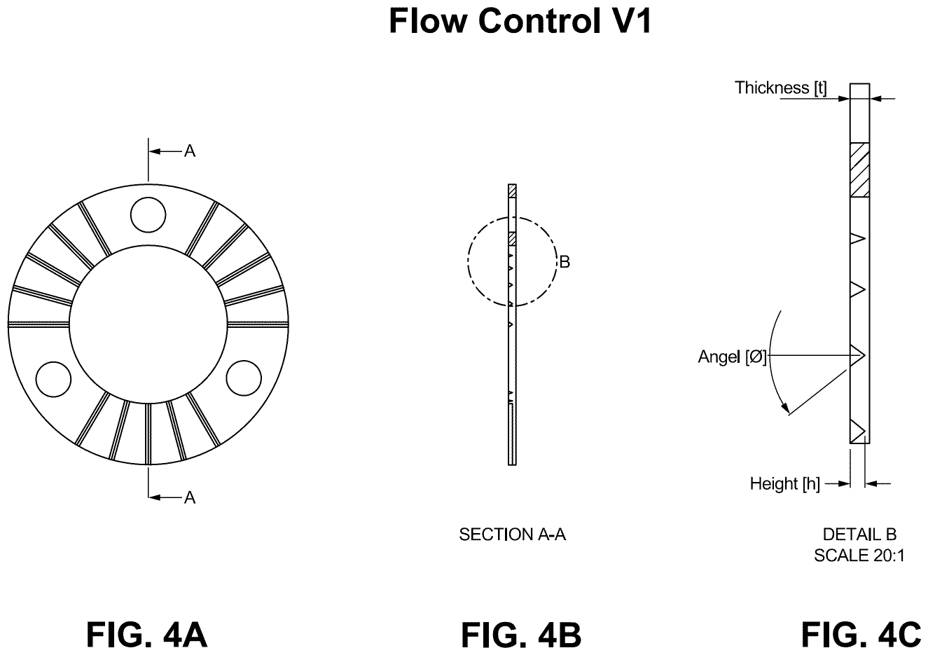

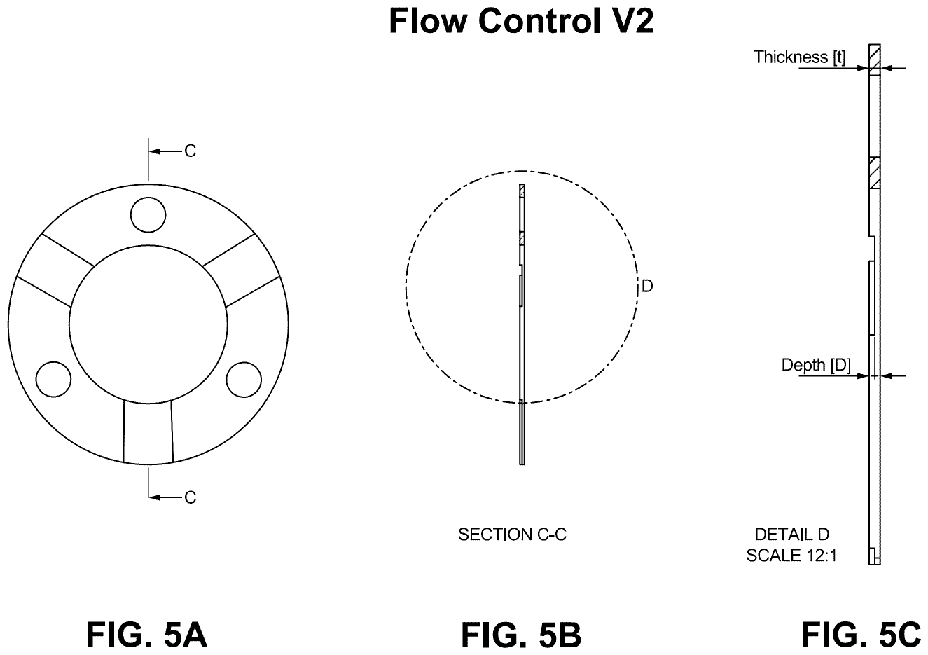

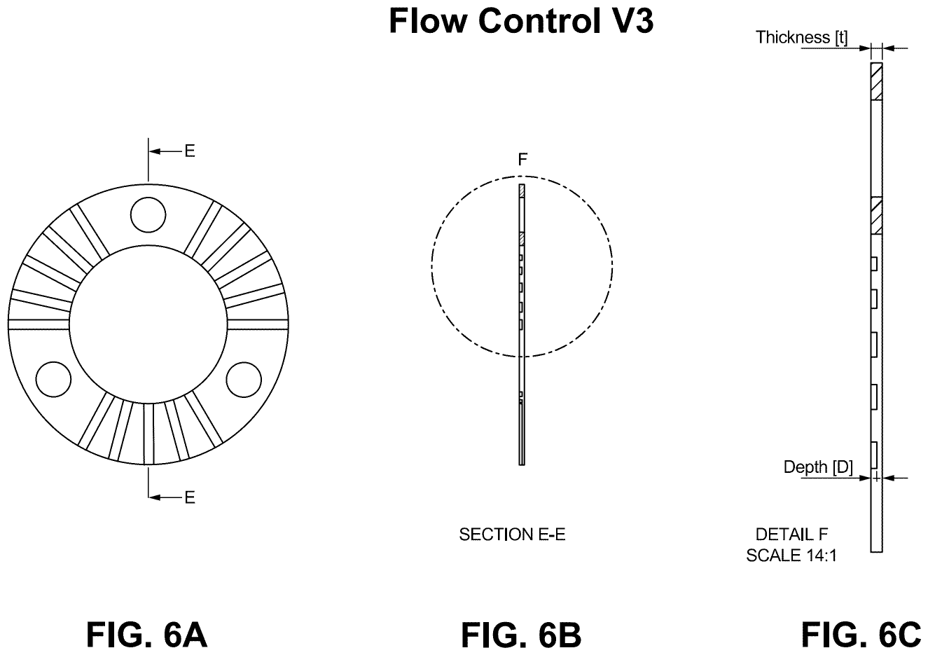

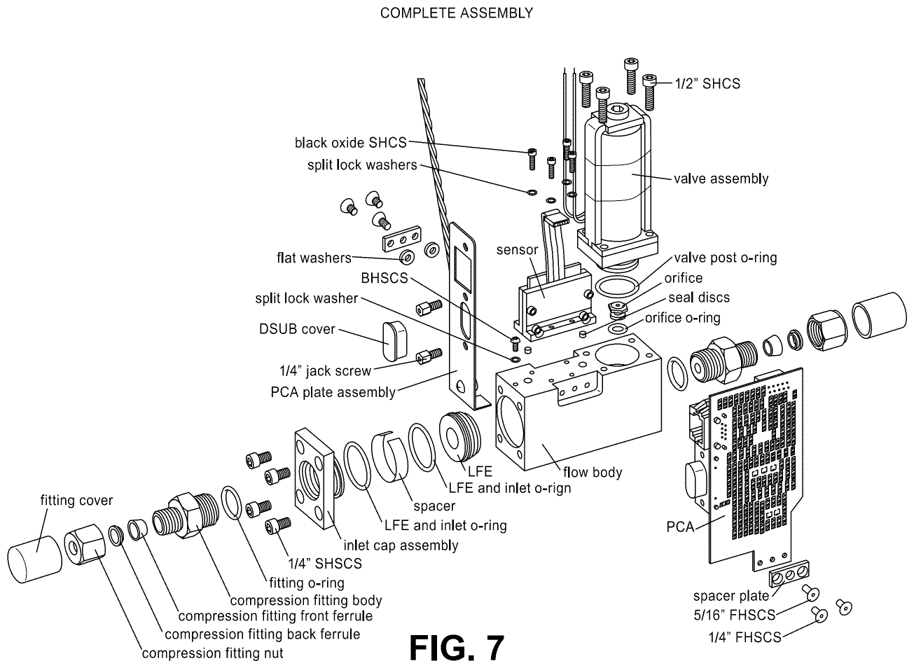

Turning now to FIGS. 4A-4C, 5A-5C, and 6A-6C, these show various sectional views that more fully describe and offer optional configurations for alternatives thereto. FIG. 4C illustrates a transverse section along line A-A of FIG. 4A; FIG. 5C illustrates a transverse section along line C-C of FIG. 5A; and FIG. 6C illustrates a transverse section along line E-E of FIG. 6A.

FIG. 4C depicts an angled grooves profile symmetrically spaced around the part, forming the channel. It should be appreciated that the height and angle of the grooves can be of varying dimension and size and not limited as described hereto.

FIG. 5C depicts a large flat groove profile symmetrically spaced around the part, forming the channel. It should be appreciated that the height and width of the large flat groove can be of varying dimension and size and not limited as described hereto.

FIG. 6C depicts smaller flat grooves profile symmetrically spaced around the part, forming the channel. It should be appreciated that the height and width of the smaller flat grooves can be of varying dimension and size and not limited as described hereto.

In practice, the number of transverse flow channels and corresponding layers or slices in the assembly will, naturally, vary. The transverse flow assembly may be designed for flows anywhere from a fraction of a liter to 1000 liters per minute, or more. Accordingly, the present disclosure contemplates situations where at least one laminar flow channel and as many as 1000, or more, may be employed. Stacks upward of 500 slice elements with correspondingly numbered transverse laminar flow channels may be employed. However, it is to be appreciated that it will generally instead be advantageous to enlarge, for example, the device diameter and have larger laminar flow channels (still having a low enough Reynolds number (Re) to ensure laminar flow) rather than simply increasing the number of layers that need to be assembled to accommodate a given application. Such variation in design will be specific to a given application and such optimization is within the common level of skill in the art.

In any case, the present flow meters and controllers allow users to read and control flow respectively. The amount of flow the meter can properly read is determined by the number of layers in the laminar flow element. The more layers the higher flow the unit can read or control. Above being easier to handle a single piece compared to multi-pieces per layer, the main purpose of the results below is to prove the performance of the present device (“single-piece” configuration) is equal to or better than the previous devices (“multi-piece” configuration). Performance can be quantified in two ways: repeatability and linearity. Repeatability is the ability to recreate the same flow rate by using the same number of layers. This is determined by building a laminar flow element to a specific number of layers and running pressure difference across the assembly. By way of example, if the pressure difference is between the range of 1.6 and 2.1 Kpa, then the laminar flow element is considered a “pass” for that specific flow rate. This is then checked again with software by looking at the Temperature Compensation Differential value. By way of example, if this value sits within the range of 1.5 and 2.2 at full scale flow, the laminar flow element is considered a “pass.” Linearity is the ability for a flow rate to be within our desired tolerance of +/−0.5% of flow rate's full scale when reading/controlling flow at 25%, 50%, and 75% of full scale (percentage values may vary depending on customer requests). For example, a unit built to read 100 lpm. This unit should also be able to read 25, 50, and 75 lpm withing the tolerance of +/−0.5 lpm.

In comparing the present single-piece laminar flow element with the previous multi-piece laminar flow element, efficiency and compatibility have been achieved. See Tables 1 and 2 below. PP=Pie Pieces, used in case of multi-piece LFE, NPP=New Pie Pieces, used in case of single piece LFE.

TABLE 1
Repeatability Results for a conventional
multi-piece laminar flow element

| | | Pressure | TC | |
|---|---|---|---|---|
| LFE | LFE Flow | Differential | Differential | LFE Recipe |
| # | Rate (SLPM) | (KPa) | (V) | (Stack Size) |
| 1 | 1 | 1.72 | 1.73 | 1 PP 8 (200) |
| 2 | 1 | 1.83 | 1.85 | 1 PP 7 (200) |
| 3 | 1 | 1.88 | 1.87 | 1 PP 7 (200) |
| 4 | 1.5 | 1.79 | 1.82 | 2 PP |
| 5 | 1.5 | 1.91 | 1.99 | 2 PP |
| 6 | 2 | 1.8 | 1.9 | 3 PP 2 (200) |
| 7 | 2 | 1.76 | 1.835 | 3 PP 2 (200) |
| 8 | 2 | 2.07 | 2.11 | 3 PP |
| 9 | 2.5 | 1.62 | 1.72 | 4 PP |
| 10 | 2.5 | 1.68 | 1.74 | 4 PP |
| 11 | 3 | 1.71 | 1.85 | 4 PP 4 (200) |
| 12 | 3 | 1.65 | 1.77 | 4 PP 4 (200) |
| 13 | 3 | 1.64 | 1.76 | 4 PP 4 (200) |
| 14 | 3 | 1.82 | 1.77 | 4 PP 4 (200) |
| 15 | 3 | 1.67 | 1.77 | 4 PP 4 (200) |
| 16 | 3.5 | 1.79 | 1.84 | 5 PP 2(200) |
| 17 | 3.5 | 1.72 | 1.8 | 5 PP 2(200) |
| 18 | 4 | 1.8 | 1.83 | 5 PP 8 (200) |
| 19 | 4 | 1.84 | 1.89 | 5 PP 8 (200) |
| 20 | 4.5 | 1.79 | 1.85 | 6 PP 2 (200) |
| 21 | 4.5 | 1.87 | 1.96 | 6 PP 2 (200) |
| 22 | 5 | 2.35 | 2.27 | 6 PP 5 (200) |
| 23 | 5 | 1.73 | 1.76 | 7 PP |
| 24 | 5 | 1.7 | 1.75 | 7 PP |
| 25 | 750 sccm | 1.89 | 1.99 | 1 PP 4 (200) |
| 26 | 750 sccm | 1.87 | 2.05 | 1 PP 4 (200) |
| 27 | 500 sccm | 1.83 | 1.85 | 1 PP 2 (200) |
| | | | | 1(35) |
| 28 | 500 sccm | 1.88 | 1.9 | 1 PP 2 (200) |
| | | | | 1(35) |

TABLE 2
Repeatability Results for a single-piece laminar flow element

| | | Pressure | TC | | |
|---|---|---|---|---|---|
| LFE | LFE Flow | Differential | Differential | LFE Recipe | |
| # | Rate (SLPM) | (KPa) | (V) | (Stack Size) | |
| 1 | 1 | 1.84 | 1.88 | 1 | NPP |
| 2 | 1 | 1.78 | 1.90 | 1 | NPP |
| 3 | 1.5 | 1.68 | 1.69 | 1 NPP 4 | (35) |
| 4 | 1.5 | 1.75 | 1.78 | 1 NPP 4 | (35) |
| 5 | 2 | 1.91 | 1.88 | 1 NPP 1 | (200) |
| 6 | 2 | 1.62 | 1.71 | 1 NPP 1 | (200) |
| 7 | 3 | 1.75 | 1.80 | 2 | NPP |
| 8 | 4 | 1.95 | 2.05 | 3 | NPP |
| 9 | 5 | 1.67 | 1.68 | 4 | NPP |
| 10 | 5 | 1.81 | 1.88 | 4 | NPP |
| 11 | 6 | 1.79 | 1.85 | 5 | NPP |
| 12 | 6 | 1.82 | 1.92 | 5 | NPP |
| 13 | 7 | 1.55 | 1.67 | 6 | NPP |
| 14 | 8 | 1.71 | 1.66 | 6 | NPP |
| 15 | 8 | 1.89 | 2.01 | 6 | NPP |
| 16 | 9 | 1.76 | 1.84 | 7 | NPP |
| 17 | 10 | 1.85 | 1.90 | 7 | NPP |
| 18 | 10 | 1.94 | 2.07 | 7 | NPP |
| 19 | 15 | 1.78 | 1.95 | 10 | NPP |
| 20 | 20 | 1.92 | 1.99 | 15 | NPP |
| 21 | 20 | 1.81 | 1.86 | 15 | NPP |
| 22 | 25 | 1.84 | 1.91 | 20 | NPP |
| 23 | 25 | 1.75 | 1.83 | 20 | NPP |
| 24 | 30 | 1.81 | 1.88 | 20 | NPP |
| 25 | 35 | 1.75 | 1.86 | 24 | NPP |
| 26 | 40 | 1.75 | 1.83 | 27 | NPP |
| 27 | 45 | 1.84 | 1.92 | 30 | NPP |
| 28 | 50 | 1.85 | 1.81 | 34 | NPP |
| 29 | 12 | 1.79 | 1.85 | 5 NPP 3 | (200) |
| 30 | 20 | 1.88 | 1.89 | 15 | NPP |

Based on the results above, repeatability is shown in both types of laminar flow devices by the consistency of the amount of layer per flow rate, measured in standard liters per minute (SLPM). Because all the pressure differentials and TC Differential are within the desired range, the units are a pass.

As for the linearity test results, a handful of units were put through calibration to test the linearity capabilities of the laminar flow elements. Below are examples of units that passed the test. This was achieved by tightening the tolerances to get a more consistent part. Passing both tests allows the present laminar flow elements build to go into production.

### 15 SLPM Unit Passes Linearity Test

| Output Goal | Actual Output | Actual Flow | Flow Goal | Meter |
|---|---|---|---|---|
| (V) | (V) | (SLPM) | (SLPM) | Verification |
| 0.000 | 0.000 | 0.0000 | 0.0000 | Passed |
| 1.250 | 1.248 | 3.8603 | 3.7440 | Passed |
| 2.500 | 2.500 | 7.6005 | 7.5000 | Passed |
| 3.750 | 3.750 | 11.2957 | 11.2500 | Passed |
| 5.000 | 5.002 | 15.0139 | 15.0060 | Passed |

### Second 15 SLPM Unit Passes Linearity Test

| Output Goal | Actual Output | Actual Flow | Flow Goal | Meter |
|---|---|---|---|---|
| (V) | (V) | (SLPM) | (SLPM) | Verification |
| 0.000 | 0.000 | 0.0000 | 0.0000 | Passed |
| 1.250 | 1.248 | 3.8795 | 3.7440 | Passed |
| 2.500 | 2.497 | 7.6239 | 7.4910 | Passed |
| 3.750 | 3.748 | 11.3160 | 11.2440 | Passed |
| 5.000 | 4.997 | 15.0007 | 14.9910 | Passed |

### 30 SLPM Unit Passes Linearity Test

| Output Goal | Actual Output | Actual Flow | Flow Goal | Meter |
|---|---|---|---|---|
| (V) | (V) | (SLPM) | (SLPM) | Verification |
| 0.000 | 0.000 | 0.0000 | 0.0000 | Passed |
| 1.250 | 1.250 | 7.7800 | 7.5000 | Passed |
| 2.500 | 2.500 | 15.2700 | 15.0000 | Passed |
| 3.750 | 3.747 | 22.6226 | 22.4820 | Passed |
| 5.000 | 5.009 | 30.0456 | 30.0540 | Passed |

In conclusion, these results prove the performance of the single-piece laminar flow element is consistent with the known multi-piece laminar flow element. This can be proven in three methods. For example, build the laminar flow elements to a specific flow rate by stacking laminar flow element layers until you get a pressure difference across the laminar flow element within the range of 1.6 to 2.1 Kpa. Another example is to confirm the built laminar flow element will work with the electronics by checking a variable called the Temperature Compensation Differential (TC Diff). This variable is directly related to the flow going through the laminar flow element and must be withing the range of 1.5 and 2.2 V at full scale flow. If a unit is out of this range, the laminar flow element is modified until both goals are reached (both variables are within the proper ranges). The results from the data above show every time a laminar flow element is built to a specific flow rate and was within the pressure difference range, the TC Differential always landed in the desired range as well. This proves the present laminar flow element build works great at full scale flow rate. The last example is to verify to make sure accurate readings is obtained when not reading full scale flow and where the linearity test takes place. The results above show how the present laminar flow elements can be within the desired tolerances when measuring flow outside of full scale (+/−0.5% of full scale).

Now to the discussion of test data and numerical simulations. In order to demonstrate the new present device is equal to, or better than the current device(s), simulations using COMSOL Multiphysics® was used. For numerical simulations, Computational Fluid Dynamics (CFD) simulations were employed due to their ability to provide detailed visualizations and accurate predictions of fluid behavior. They also enable early detection of design flaws and allow for the simulation of conditions that are difficult or impossible to reproduce experimentally. Moreover, simulations enable us to verify the tested results and collect data on alternative designs without the need to physically manufacture each one

In one implementation, turbulent flow, k-ε interface of the CFD module of COMSOL Multiphysics was used for simulations. This physics interface is suitable for incompressible flows, weakly compressible flows, and compressible flows at low Mach numbers (typically less than 0.3). Turbulent flow, k-ε interface is most widely used since it often is a good compromise between accuracy and computational cost.

In CFD simulations, meshing is the crucial process of dividing a continuous fluid domain into smaller, discrete elements called cells or control volumes. This discretization enables computers to numerically solve the governing equations of fluid flow. It is important to mention that with COMSOL, only the fluid domain is modeled, meaning that the negative space (i.e., the volume occupied by the fluid around solid parts) is used for simulations.

In one implementation, the gap between two consecutive LFE layers being very tiny (6.35*10⁻⁵ m), it is important to have a fine mesh with several element per thickness. For a better analysis of fluid dynamics in the LFE area, each gap between LFEs was divided into 8 elements. Elsewhere, the mesh element was relatively bigger, to avoid memory issues during the study.

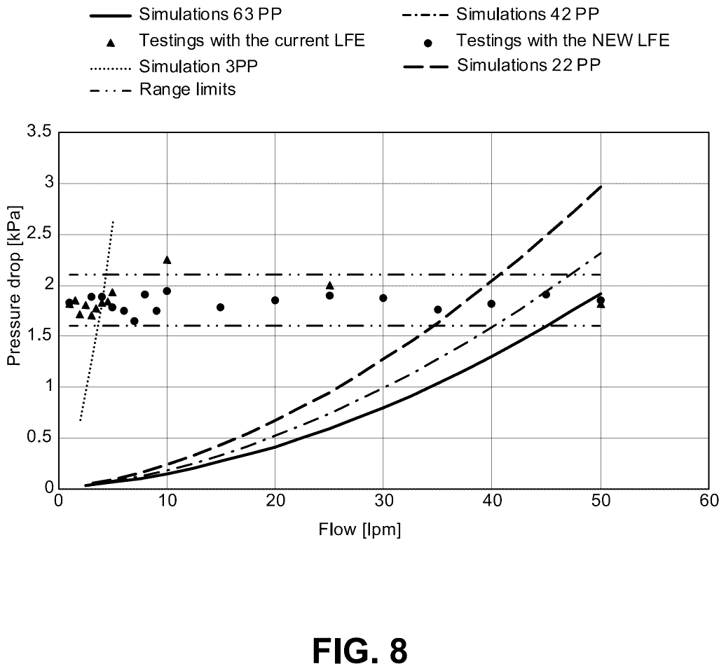

Referring to FIG. 8, laminar flow, in fluid dynamics, is characterized by smooth, parallel layers of fluid motion with minimal mixing. This type of flow exhibits a linear relationship between pressure drop and flow rate, meaning that as the flow rate increases, the pressure drops increase proportionally. During the characterization of the meter, the pressure drop is verified at full-scale. With simulations, the whole turn-down can be covered with less additional effort, and we are able to see the pressure differential across the LFE increasing with the flow. FIG. 8 presents the pressure drop across the LFE as a function of the inlet flow rate. As shown, solid or dash line plots represent simulation results. These simulations confirmed the fact that to maintain the pressure drop across the LFE, the number of LFE layers should be adjusted accordingly. To reduce the pressure differential, the number of LFE layers should be increased and vice versa.

Many LFE assemblies/stacks were built and used in a flow body and characterized. Markers in FIG. 8 represent the measurement done with the current LFE design (designated with “triangles markers”) and the present LFE device (designated with “round dots markers”). Every marker represents the average of the pressure drop measured with two or three LFE assemblies of same x-number of pie pieces (PP) or new pie pieces (NPP).

As shown by the graph in FIG. 8, these results indicate that the pressure drop observed in the numerical simulations, for instance at 50 lpm, closely matches the experimental results. Additionally, both simulation and testing confirm that increasing the number of pie pieces (PP) leads to a reduction in pressure drop.

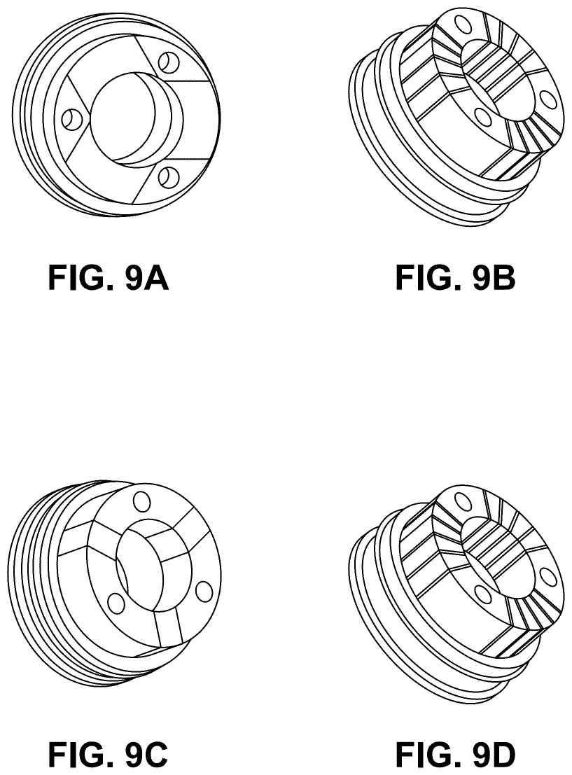

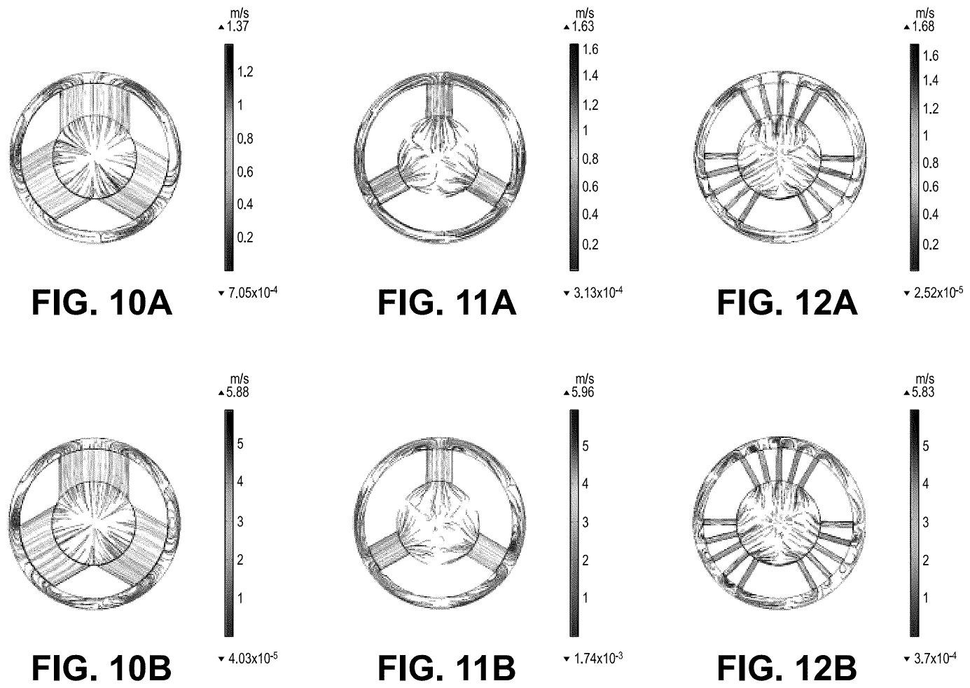

Simulations were also performed on alternative LFE designs presented in FIGS. 9A-D. FIGS. 10A10B, FIGS. 11A-11B and FIGS. 12-A-12B show streamline of three different designs respectively presented in FIG. 9A, FIG. 9C and FIG. 9D. In fluid mechanics, streamlines are imaginary lines that represent the path of a fluid particle in motion, specifically at a given instant in time, and are tangent to the velocity vector at every point along the line. It can be observed that dividing the slot size by 3 leads to same flow streamlines in the flow channel 22. Vortices are observed right at the outlet of the flow channels for the three designs. This observation is still valid when varying the inlet flowrate.

It should be appreciated that with a larger slot (FIG. 10A-10B), there are less vortices near the walls of the flow body. When the slot of the LFE is too small (FIG. 11A-11B, FIG. 12A-12B), this can create a change in the flow property, switching from laminar to turbulent flow, making the flow control and measurement less predictable. For more stable and repeatable flow control and measurements, larger slots are ideal.

Referring now to the Computational Fluid Dynamics (CFD) results of different LFE designs associated with streamlines.

FIG. 10A depicts the inlet flow simulation of the present LFE device of FIG. 9A, FIG. 11A depicts the inlet flow simulation of alternative LFE device V2 (FIG. 9C) and FIG. 12A depicts the inlet flow simulation of alternative LFE device V3 (FIG. 9D). In this testing simulation, the inlet flow was tested at 1 l/min with a Reynolds number (Re) of approximately 175. When comparing the streamlines in the respective simulations, they show the flow to be more turbulent in the alternative LFE device V2 and V3 (FIG. 9C and FIG. 9D).

FIG. 10B depicts the inlet flow simulation of the present LFE device of FIG. 9A, FIG. 11B depicts the inlet flow simulation of alternative LFE device V2 (FIG. 9C) and FIG. 12B depicts the inlet flow simulation of alternative LFE device V3 (FIG. 9D). In this testing simulation, the inlet flow was tested at 4 l/min with a Reynolds number (Re) of approximately 700. When comparing the streamlines in the respective simulations, they show the flow to be more turbulent in the alternative LFE device V2 and V3 (FIG. 9C and FIG. 9D). The observation is the same when increasing the inlet flow.

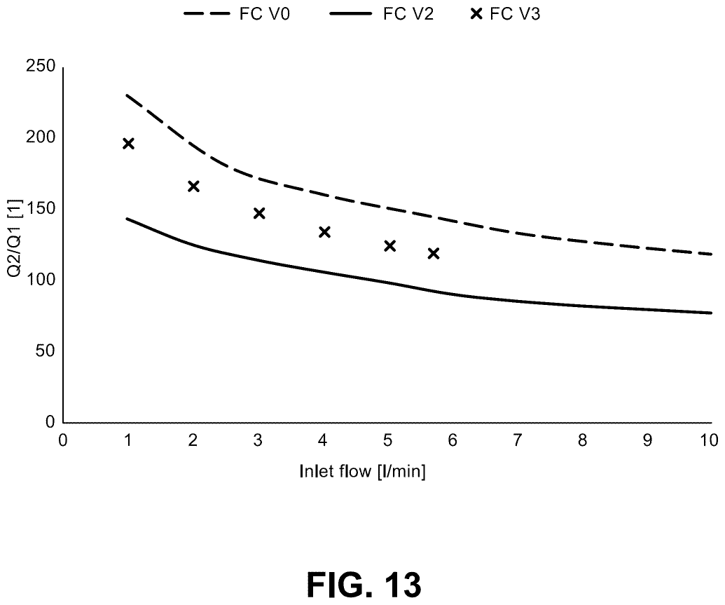

FIG. 13 is a graph that shows the Q2 (flow inside the bypass)/Q1 (flow inside the sensor tube) ratio for the design V0 and an alternative design V2 and V3 presented in the FIG. 9. One can see that in both cases Q2/Q1 is at first high. This can be explained by the fact the flow goes mostly through the bypass, since the pressure drop is not high enough. Then this ratio decreases and will become constant. One can also notice that the Q2/Q1 ratio curve of the different designs are parallels. This shows these designs can give the same results, by adjusting the number of LFE layers.

These results prove the performance of the new present LFE device is consistent with the current LFE device. This can be proven in three steps. First, build LFEs to a specific flow rate by stacking LFE layers until you get a pressure difference across the LFE within the specific range. Second, confirm the build LFEs will work with the electronics by checking a variable called the Temperature Compensation Differential (TC Diff). This variable is directly related to the flow going through the LFE and must be withing a specific range of 1.5 and 2.2 V at full scale flow. If a unit is out of this range, the LFE is modified until both goals are reached (both variables are within the proper range). The results from the data above show that every time an LFE is built to a specific flow rate and was within the pressure difference range, the TC Diff always landed in the desired range as well. This proves the new present LFE build works great at full scale flow rate. The last step to verify was to make sure that accurate readings are achieved when not reading full scale flow and that is where the linearity test takes place. The results above show how the new present LFEs can be within the desired tolerances when measuring flow outside of full scale (spec is +/−0.5% of full scale).

The present disclosure during testing demonstrates an order of magnitude improvement in tolerances over the known technology and, thereby, yields a total instrument assembly time reduction in the range of 10% to 25%, ultimately yielding a cost-reduction benefit to the instrument's user. This time reduction stems from there being no need to add or remove slices from the stack following testing as is usually required in the conventional systems when tuning an assembly with the chemically etched slices. In addition to the above advantages, the reproducibility of the laminar flow channels also increases the accuracy of flow rate measurement.

Methods recited herein may be carried out in any order of the recited events which is logically possible, as well as the recited order of events. Furthermore, where a range of values is provided, it is understood that every intervening value, between the upper and lower limit of that range and any other stated or intervening value in the stated range is encompassed within the invention. Also, it is contemplated that any optional feature of the inventive variations described may be set forth and claimed independently, or in combination with any one or more of the features described herein.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A laminar flow element, comprising:
a single-piece layer of sheet stock having a first surface and a second surface opposite the first surface, the single-piece layer being an annular flat disk,
wherein the first surface includes at least one channel formed by etching,
wherein sidewalls are formed by the at least one channel, and
wherein a height of the sidewalls is configured to create a transverse laminar flow.

2. The laminar flow element of claim 1, wherein the at least one channel is rectangularly-shaped.

3. The laminar flow element of claim 1, wherein the at least one channel is trapezoidally-shaped.

4. The laminar flow element of claim 1, wherein the first surface includes three channels spaced equally on the annular flat disk.

5. The laminar flow element of claim 1, wherein the at least one channel includes a plurality of grooves.

6. The laminar flow element of claim 5, wherein each groove has an angled profile.

7. The laminar flow element of claim 5, wherein each groove has a flat profile.

8. The laminar flow element of claim 1, wherein the at least one channel includes one large groove.

9. The laminar flow element of claim 8, wherein the one large groove has an angled profile.

10. The laminar flow element of claim 8, wherein the one large groove has a flat profile.

11. The laminar flow element of claim 1, wherein the sidewalls of the channel are substantially parallel.

12. The laminar flow element of claim 1, wherein the height of the sidewalls is at least half of the thickness of the single-piece layer.

13. The laminar flow element of claim 1, wherein the single-piece layer has a thickness of between 0.001 inches to 0.050 inches.

14. The laminar flow element of claim 1, wherein the sheet stock comprises metal shim stock.

15. A laminar flow assembly, comprising:
a plurality of single-piece layers of sheet stock forming an interior transverse flow channel along an axis,
wherein each layer includes a first surface and a second surface opposite the first surface, the layer being an annular flat disk,
wherein the first surface includes at least one channel formed by etching,
wherein sidewalls are formed by the at least one channel, and
wherein a height of the sidewalls is configured to create a transverse laminar flow.
